(19) United States
(12) Patent Application Publication
(10) Pub. No.: US 2014/0125059 A1
(43) Pub. Date: May 8, 2014

(54) ELECTRIC VEHICLE

(71) Applicant: Mingjun Chen, Shenzhen (CN)

(72) Inventor: Mingjun Chen, Shenzhen (CN)

(21) Appl. No.: 14/128,585

(22) PCT Filed: Jul. 18, 2011
(86) PCT No.: PCT/CN2011/077275

§ 371 Date: Dec. 20, 2013

(30) Foreign Application Priority Data
Jul. 12, 2011 (CN) 201110193861.2

(51) Int. Cl. B60L 11/16

(52) U.S. Cl. CPC B60L 11/16
USPC 290/45

(57) ABSTRACT

An electric vehicle comprises an air tank (11, 21, 31) and an air turbine (12, 22, 32) connected to the air tank and an electrical power generator (13, 23, 33) respectively. The air tank is provided with an air charging interface and a switching valve, external compressed air is stored into the air tank through the air charging interface, and the stored compressed air is output to the air turbine under the control of the switching valve. The air turbine converts air energy of the input compressed air into kinetic energy for driving the electrical power generator to generator power. The electrical power generator is connected to the driving motor (14, 24, 34) and is used for supplying power to the driving motor when generating power. The electric vehicle has increased travel distance per charge and elongated service life of the storage battery, and is environmental friendly and energy saving.

### CROSS REFERENCE TO RELATED APPLICATIONS

This application claims the benefit of priority to China patent application NO. 201110193861.2 filed in the Chinese Patent Office on Jul. 12, 2011 and entitled “ELECTRIC VEHICLE”, the content of which is incorporated herein by reference in its entirety.

### FIELD

The present invention relates to the technical field of electric vehicle, and more particularly, to an electric vehicle.

### BACKGROUND

Currently, electric vehicles are basically classified into pure electric vehicles and hybrid electric vehicles. In an existing pure electric vehicle, power is mainly supplied by a battery. It is a drawback that it needs to take some time to charge the battery every time. When the user needs to use the electric vehicle immediately but the battery is empty, it will cause great inconvenience to the travel of the user. In a hybrid electric vehicle, a fuel generator is added on a basic structure of the pure electric vehicle, and the above drawback of the pure electric vehicle is overcome. However, the hybrid electric vehicle brings some new problems, which are mainly in the following aspects. Firstly, the fuel that it uses is non-renewable resources. When fuel is burned during the car driving, carbon dioxide gas is exhausted, which causes heavy pollution to the environment and is adverse to the concept “green travel” promoted in the world. Secondly, rising fuel prices increase the using cost of the hybrid electric vehicle. Therefore, it has been a problem pressing for solution in the electric vehicle technical field to design an electric vehicle that can supply power quickly, and is also environmentally friendly.

### SUMMARY

One technical problem to be solved in embodiments of the present invention is to provide an electric vehicle that has an enhanced continuous mileage and a prolonged service life of battery, and is also environmentally friendly.

To achieve the above purpose, one embodiments of the present invention provide an electric vehicle that comprises an electrical power generator and a driving motor. In addition, the electric vehicle further comprises: an air tank and an air turbine, the air turbine is connected to the air tank and the n electrical power generator respectively;

the air tank is provided with an air charging interface and a switching valve, external compressed air is stored into the air tank through the air charging interface, and the stored compressed air is output to the air turbine under the control of the switching valve;

the air turbine converts air energy of the input compressed air into kinetic energy to drive the electrical power generator to generate power; and

the electrical power generator is connected to the driving motor and is used for supplying power to the driving motor when generating power.

Further, the electric vehicle further comprises: a charging circuit and a battery connected to each other, wherein the battery is connected to the driving motor.

Further, the electrical power generator is connected to the driving motor and the battery, respectively, to supply power to the driving motor and to charge the battery when generating power.

Further, the electrical power generator is a direct current generator or an alternating current generator.

Further, the electric vehicle further comprises a decompression valve connected between the air tank and the air turbine, wherein the decompression valve is used for decompressing the air outputted by the air tank.

Further, the electric vehicle further comprises a gas storage apparatus connected to a vent of the air turbine, wherein the gas storage apparatus is provided with an opening facing to a passenger space in the electric vehicle, the opening is provided with a switch valve, and the gas in the gas storage apparatus is exhausted from the opening to the passenger space of the electric vehicle when the switch valve is opened.

Further, the electric vehicle further comprises an airway connected to the vent of the air turbine, and the gas discharged by the vent is guided by the airway to the battery to exhaust.

Further, the electric vehicle is further provided with a power supply control apparatus, the power supply control apparatus is used for controlling all of the power generated by the electrical power generator to be provided to the driving motor, or for controlling a portion of the power generated by the electrical power generator to be provided to the driving motor and another portion of the power generated by the electrical power generator to be provided to the battery.

Further, the power supply control apparatus comprising:

a detection unit for detecting an amount of the power generated by the electrical power generator and an amount of power required by the driving electric motor during running of the electric vehicle;

a comparison unit for comparing the detected amount of the generated power with the detected amount of the required power, wherein, when the amount of the generated power is greater than the amount of the required power, the comparison unit sends out a first control signal, and otherwise, the comparison unit sends out a second control signal; and

a control unit for, when receiving the first control signal, controlling the electrical power generator to provide an amount of the generated power equal to the amount of the required power to the driving electric motor, and to put a portion of the generated power exceeding the amount of the required power to the battery to charge the battery; and when receiving the second control signal, controlling the electrical power generator to provide all of the amount of the generated power to the driving electric motor.

In the implementation of an electric vehicle provided in one embodiment of the present invention, the following beneficial effects can be achieved.

Firstly, by providing an air tank, an air turbine and a electrical power generator, the air energy of external compressed air can be utilized to generate electrical power. Thus, without causing environmental pollution, not only power can be supplied quickly to the electric vehicle, but also the vehicle is environmentally friendly.

Secondly, by providing an airway, cold air exhausted by the above air turbine can be guided to the battery to exhaust there, which avoids that the battery works in a high temperature environment and helps to prolong the service life of the battery.

Thirdly, by providing a gas storage apparatus and an opening facing to the passenger space in the electric vehicle, the cold air exhausted by the above air turbine is discharged to the passenger space. Thereby, the passenger can enjoy the same cooling effect as that of an air conditioner without using any air conditioners, and therefore, energy can be saved.

### BRIEF DESCRIPTION OF THE DRAWINGS

In order to more clearly illustrate embodiments of the present invention or technical solutions in existing technology, drawings assisting in describing the embodiments or existing technology are briefly introduced below. It is apparent that the drawings in the following description are only some embodiments of the present invention. A person having ordinary skills in the art can also obtain other drawings on the basis of these drawings without paying any creative work.

FIG. 1 is a structure diagram of a first embodiment of an electric vehicle provided by the present invention;

FIG. 2 is a structure diagram of a second embodiment of an electric vehicle provided the present invention;

FIG. 3 is a structure diagram of a third embodiment of an electric vehicle provided the present invention;

FIG. 4 is a structure diagram of a power supply control apparatus of an electric vehicle provided the present invention.

### DETAILED DESCRIPTION OF ILLUSTRATED EMBODIMENTS

Technical solutions in embodiments of the present invention will be illustrated clearly and entirely with the aid of the drawings in the embodiments of the present invention. Obviously, the described embodiments herein are only a part of embodiments, but not all of embodiments. Based on the embodiments of the present invention, all of other embodiments obtained by a skilled person in the art without paying any creative work should fall within the protection scope of the present invention.

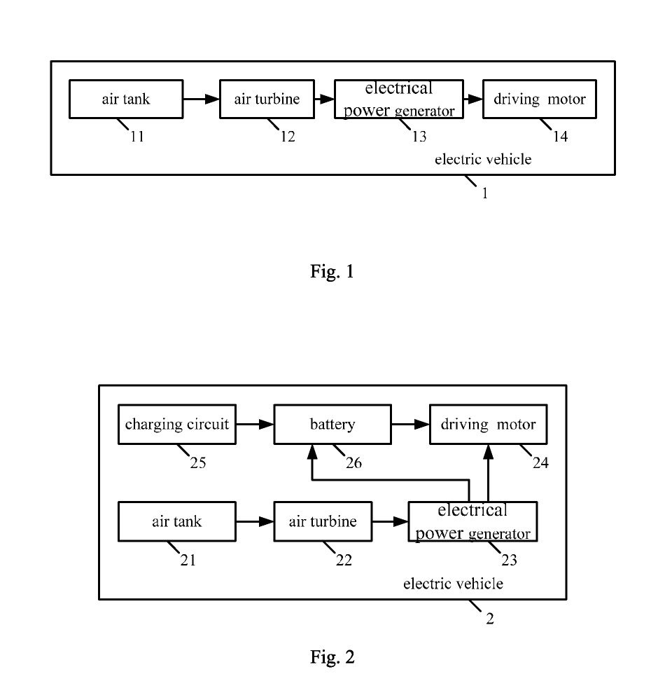

Referring to FIG. 1, it is a structure diagram of a first embodiment of an electric vehicle provided by the present invention. As shown in FIG. 1, the electric vehicle 1 comprises an air tank 11, an air turbine 12, an electrical power generator 13 and a driving motor 14. The air tank 11, the air turbine 12, the generator 13 and the driving motor 14 are connected to together.

The air tank 11 is provided with an air charging interface and a switching valve, external compressed air is stored into the air tank 11 through the air charging interface. When using the air tank 11, the switching valve may be opened and the stored compressed air is output to the air turbine 12.

Specifically, the external compressed air may come from a relatively larger gas storage apparatus or a relatively larger gas storage network. When the compressed air in the air tank 11 in the electric vehicle is used up, the air tank 11 may be supplied with air through the air charging interface from the gas storage apparatus or the gas storage network. Supplying air is simple and quick, which takes much shorter time than charging battery for ordinary electric vehicles. Thus, the electric vehicle may be supplied with air quickly and thereby be supplied with power quickly.

The air turbine 12 converts air energy of the input compressed air into kinetic energy to drive the electrical power generator 13 to generate power.

The electrical power generator 13 is connected to the driving motor 14 and is used for supplying power to the driving motor 14 when generating power.

Specifically, the electrical power generator is a direct current generator or an alternating current generator.

In the implementation of the electric vehicle provided in one embodiment of the present invention, the following beneficial effects can be achieved.

By providing an air tank, an air turbine and an electrical power generator, the air energy of external compressed air can be utilized to generate electrical power. Thus, without causing environmental pollution, not only power can be supplied quickly to the electric vehicle, but also the vehicle is environmentally friendly.

Referring to FIG. 2, it is a structure diagram of a second embodiment of an electric vehicle provided by the present invention. As shown in FIG. 2, the electric vehicle 2 comprises an air tank 21, an air turbine 22, an electrical power generator 23, a driving motor 24, a charging circuit 25 and a battery 26. The air tank 21, the air turbine 22, the electrical power generator 23 and the driving motor 24 are connected to together. The charging circuit 25, the battery 26 and the driving motor 24 are connected to together.

Preferably, the electrical power generator 23 is also connected to the battery 26 and is used for charging the battery when generating power.

The air tank 21 is provided with an air charging interface and a switching valve, external compressed air is stored into the air tank 21 through the air charging interface. When using the air tank 11, the switching valve may be opened and the stored compressed air is output to the air turbine 22.

Specifically, the external compressed air may come from a relatively larger gas storage apparatus or a relatively larger gas storage network. When the compressed air in the air tank 21 in the electric vehicle is used up, the air tank 21 may be supplied with air through the air charging interface from the gas storage apparatus or the gas storage network. Supplying air is simple and quick, which takes much shorter time than charging battery for ordinary electric vehicles. Thus, the electric vehicle may be supplied with air quickly and thereby be supplied with power quickly.

The air turbine 22 converts air energy of the input compressed air into kinetic energy to drive the electrical power generator 23 to generate power.

The electrical power generator 23 is connected to the driving motor 24 and the battery 26, respectively, to supply power to the driving motor 24 and to charge the battery 26 when generating power.

Specifically, the electrical power generator is a direct current generator or an alternating current generator.

When the charging circuit 25 is connected to an external electrical power, the battery 26 is charged and supplies power to the driving electric motor 24.

In the implementation of the electric vehicle provided in one embodiment of the present invention, the following beneficial effects can be achieved.

By providing an air tank, an air turbine and an electrical power generator, the air energy of external compressed air can be utilized to generate electrical power. Thus, without causing environmental pollution, not only power can be supplied quickly to the electric vehicle, but also the vehicle is environmentally friendly.

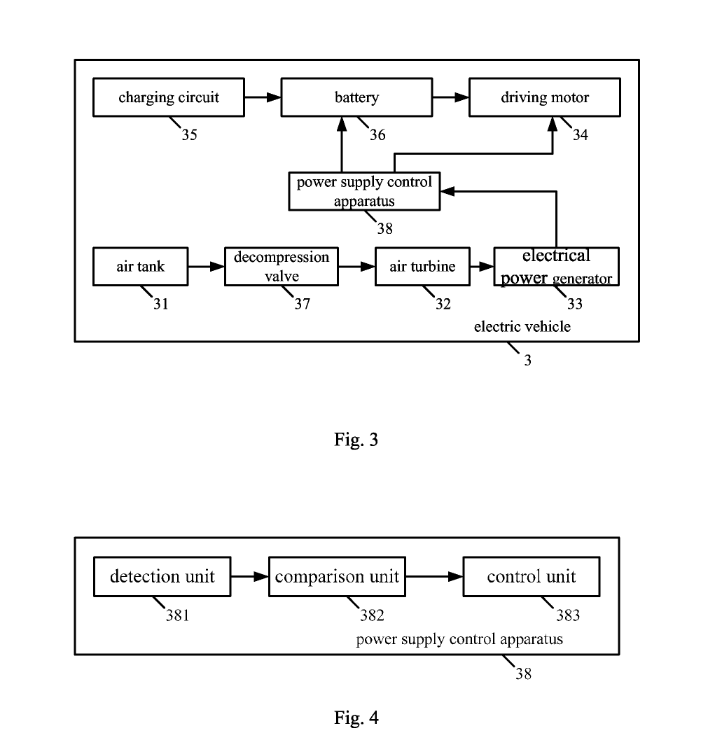

Referring to FIG. 3, it is a structure diagram of a third embodiment of an electric vehicle provided by the present invention. As shown in FIG. 3, the electric vehicle 3 comprises an air tank 31, an air turbine 32, an electrical power generator 33, a driving motor 34, a charging circuit 35, a battery 36, a decompression valve 37 and a power supply control apparatus 38. The decompression valve 37 is connected between the air tank 31 and the air turbine 32. The air tank 31, the air turbine 32, the electrical power generator 33 and the driving motor 34 are connected to together. The charging circuit 35, the battery 36 and the driving motor 34 are connected to together.

Specifically, the electrical power generator 33 is connected to the battery 36 and the driving motor 34 through the power supply control apparatus 38.

The air tank 31 is provided with an air charging interface and a switching valve, external compressed air is stored into the air tank 31 through the air charging interface. When using the air tank 11, the switching valve may be opened and the stored compressed air is output to the air turbine 32.

Specifically, the external compressed air may come from a relatively larger gas storage apparatus or a relatively larger gas storage network. When the compressed air in the air tank 31 in the electric vehicle is used up, the air tank 31 may be supplied with air through the air charging interface from the gas storage apparatus or the gas storage network. Supplying air is simple and quick, which takes much shorter time than charging battery for ordinary electric vehicles. Thus, the electric vehicle may be supplied with air quickly and thereby be supplied with power quickly.

The decompression valve 37 is used for decompressing the air outputted by the air tank 31 to input the air turbine 32.

The air turbine 32 converts air energy of the input compressed air into kinetic energy to drive the electrical power generator 33 to generate power.

Specifically, by providing an airway in the vent of the air turbine 32, cold air exhausted by the above air turbine can be guided to the battery to exhaust there, which avoids that the battery works in a high temperature environment and helps to prolong the service life of the battery.

Preferably, a gas storage apparatus is provided in the vent of the air turbine 32. The gas storage apparatus is provided with an opening facing to a passenger space in the electric vehicle, and a switch valve is set at the opening. The gas in the gas storage apparatus is exhausted from the opening to the passenger space of the electric vehicle when the switch valve is opened. Thereby, the passenger can enjoy the same cooling effect as that of an air conditioner without using any air conditioners, and therefore, energy can be saved.

The generator 33 is connected to the driving motor 34 and the battery 36 to supply power to the driving motor 34 and to charge the battery 36 when generating power.

Specifically, the electrical power generator is a direct current generator or an alternating current generator.

When the charging circuit 35 is connected to an external electrical power, the battery 36 is charged and supplies power to the driving electric motor 34.

The power supply control apparatus 38 is used for controlling an amount of power generated by the electrical power generator 33 to supply power to the driving motor and/or to charge the battery 36.

Specifically, the power supply control apparatus 38 comprises a detection unit 381, a comparison unit 382 and a control unit 383, for which one may refer to FIG. 4.

The detection unit 381 for detecting an amount of the power generated by the electrical power generator 33 and the amount of power required by the driving electric motor 34 during running of the electric vehicle.

The comparison unit 382 for comparing the detected amount of the generated power with the detected amount of the required power, wherein, when the amount of the generated power is greater than the amount of the required power, the comparison unit sends out a first control signal, and otherwise, the comparison unit sends out a second control signal.

The control unit 383 for, when receiving the first control signal, controlling the electrical power generator 33 to provide an amount of the generated power equal to the amount of the required power to the driving electric motor 34 and to input a portion of the amount of the generated power exceeding the amount of the required power to the battery 36 to charge the battery; and when receiving the second control signal, controlling the electrical power generator 33 to provide all of the amount of the generated power to the driving electric motor 34.

In the implementation of an electric vehicle provided in one embodiment of the present invention, the following beneficial effects can be achieved.

Firstly, by providing an air tank, an air turbine and a electrical power generator, the air energy of external compressed air can be utilized to generate electrical power. Thus, without causing environmental pollution, not only power can be supplied quickly to the electric vehicle, but also the vehicle is environmentally friendly.

Secondly, by providing an airway, cold air exhausted by the above air turbine can be guided to the battery to exhaust there, which avoids that the battery works in a high temperature environment and helps to prolong the service life of the battery.

Thirdly, by providing a gas storage apparatus and an opening facing to the passenger space in the electric vehicle, the cold air exhausted by the above air turbine is discharged to the passenger space. Thereby, the passenger can enjoy the same cooling effect as that of an air conditioner without using any air conditioners, and therefore, energy can be saved.

The above disclosure provides merely preferred embodiments of the present invention and certainly cannot be used to limit the scope of claims of the present invention. Therefore, any equivalent modification according to the present invention still falls in the protection scope of the present invention.

1. An electric vehicle, comprising an electrical power generator, a driving motor, an air tank and an air turbine, wherein:
the air turbine is connected to the air tank and the electrical power generator respectively;
the air tank is provided with an air charging interface and a switching valve, external compressed air is stored into the air tank through the air charging interface, and the stored compressed air is output to the air turbine under the control of the switching valve;
the air turbine converts air energy of the input compressed air into kinetic energy to drive the electrical power generator to generate power; and
the electrical power generator is connected to the driving motor and is used for supplying power to the driving motor when generating power.

2. The electric vehicle according to claim 1, comprising: a charging circuit and a battery, wherein the charging circuit and the battery are connected to each other, the battery is connected to the driving motor.

3. The electric vehicle according to claim 2, wherein the electrical power generator is connected to the driving motor and the battery, respectively, to supply power to the driving motor and to charge the battery when generating power.

4. The electric vehicle according to claim 1, wherein the electrical power generator is a direct current generator or an alternating current generator.

5. The electric vehicle according to claim 1, the electric vehicle further comprises comprising a decompression valve, wherein the decompression valve is connected between the air tank and the air turbine, the decompression valve is used for decompressing the air outputted by the air tank.

6. The electric vehicle according to claim 1, further comprising a gas storage apparatus, wherein the gas storage apparatus is connected to a vent of the air turbine, the gas storage apparatus is provided with an opening facing to a passenger space in the electric vehicle, the opening is provided with a switch valve, and the gas in the gas storage apparatus is exhausted from the opening to the passenger space of the electric vehicle when the switch valve is opened.

7. The electric vehicle according to claim 3, further comprising an airway, wherein the airway is connected to the vent of the air turbine, and the gas discharged by the vent is guided by the airway to the battery to exhaust.

8. The electric vehicle according to claim 3, further comprising a power supply control apparatus, wherein the power supply control apparatus is used for controlling all of the power generated by the electrical power generator to be provided to the driving motor, or for controlling a portion of the power generated by the electrical power generator to be provided to the driving motor and another portion of the power generated by the electrical power generator to be provided to the battery.

9. The electric vehicle according to claim 8, wherein the power supply control apparatus comprises:
a detection unit for detecting an amount of the power generated by the electrical power generator and an amount of power required by the driving electric motor during running of the electric vehicle;
a comparison unit for comparing the detected amount of the generated power with the detected amount of the required power, wherein, when the amount of the generated power is greater than the amount of the required power, the comparison unit sends out a first control signal, and otherwise, the comparison unit sends out a second control signal; and
a control unit for, when receiving the first control signal, controlling the electrical power generator to provide an amount of the generated power equal to the amount of the required power to the driving electric motor, and to put a portion of the amount of the generated power exceeding the amount of the required power to the battery to charge the battery; and when receiving the second control signal, controlling the electrical power generator to provide all of the amount of the generated power to the driving electric motor.

10. The electric vehicle according to claim 2, wherein the electrical power generator is a direct current generator or an alternating current generator.

11. The electric vehicle according to claim 2, further comprising a decompression valve, wherein the decompression valve is connected between the air tank and the air turbine, the decompression valve is used for decompressing the air outputted by the air tank.

12. The electric vehicle according to claim 2, further comprising a gas storage apparatus, wherein the gas storage apparatus is connected to a vent of the air turbine, the gas storage apparatus is provided with an opening facing to a passenger space in the electric vehicle, the opening is provided with a switch valve, and the gas in the gas storage apparatus is exhausted from the opening to the passenger space of the electric vehicle when the switch valve is opened.
